(19) United States
(12) Patent Application Publication
(10) Pub. No.: US 2004/0033285 A1
(43) Pub. Date: Feb. 19, 2004

(54) Roll-fed progressing cavity pump/extruder

(76) Inventor: Christopher S. Hannaford, Golden Valley, MN (US)

Correspondence Address: Wayne A. Sivertson, NAWROCKI, ROONEY & SIVERTSON, P.A., Broadway Place East, Suite 401, 3433 Broadway Street Northeast, Minneapolis, MN, 55413, US

(21) Appl. No.: 10/639,536

(22) Filed: Aug. 12, 2003

Related U.S. Application Data
(60) Provisional application No. 60/403,173, filed on Aug. 13, 2002.

(51) Int. Cl. B29C 47/36

(52) U.S. Cl. 425/376.1

(57) ABSTRACT

A pump assembly for dough-like material wherein a roll feeder delivers the material, under pressure, to a progressing cavity pump. In that process, the roll feeder also de-airs the dough. In preferred embodiments, the progressing cavity pump may be interconnected to the roll feeder by a screw feeder. The pump assembly may be employed to pump material from place to place, or alternatively, to extrude a pumped material, including delivering the pump material to an extruder.

### BACKGROUND OF THE INVENTION

The present invention relates to pumps for dough-like materials and, more particularly, to pump assemblies (with and without extrusion capability) for viscous food doughs.

Doughs and dough-like materials are found in many arts. In the foods industry, for example, doughs are used for bread and many candy products. Such doughs are typically sticky and are not truly a fluid in that they do not take the shape of a container in to which they are put. That is, a ball of dough mostly retains the shape of a ball.

In the food industry, and most particularly in the candy industry, it is often desired to produce shaped ropes, as by extruding. Because of the high viscosity (4,000,000-8,000,000 centipoises are common for licorice, for example) extrusion of such material may require the delivery of the dough at up to several hundred pounds per square inch (psi) of pressure. For many applications, it is also desirable, or necessary, to provide a mechanism which removes air bubbles from the dough.

One prior art system employs a single-screw, open-flighted extruder having an open hopper. The dough (licorice is common) is cooked continuously and dropped at atmospheric pressure into the hopper. Such extruders are limited to approximately 100 psi which limits their capabilities.

Another prior art system which is capable of generating more than 100 psi to improve extruding capabilities employs a twin-screw extruder and cooks the dough inside the extruder. By manufacturing the dough within the extruder, the problem of feeding the viscous, sticky dough is mute.

As noted above, the first mentioned prior art approach produces a pressure too low for many applications. The second described system provides sufficient pressure but is too costly for many applications. Also, in spite of the high cost, cooking the dough inside the extruder often produces an inferior dough.

In addition to extrusion applications, it is sometimes desired to simply pump the dough from one location to another. One system for this application employs two (2) non-intermeshed screws, a feed roller and a lobe pump. See U.S. Pat. No. 3,879,150. The screws de-air the dough and force it into the lobe pump while the feed rollers prevent the lump of dough from riding on top of the screws. As is apparent, even the simple transport of dough by a pump requires relatively complex, and often expensive, equipment.

### BRIEF DESCRIPTION OF THE PRESENT INVENTION

The present invention employs a progressing cavity pump which is capable of efficiently pumping high viscosity doughs and dough-like materials and generating the pressures necessary for effective extrusion applications with little shear damage. Progressing cavity pumps are known having been patented in 1932 by Rene Joseph Moineau as shown and described in U.S. Pat. No. 1,892,217.

As is well known, progressing cavity pumps work well for products that can flow into their inlet hopper—those that are fluid as opposed to dough-like as represented generally by their viscosity. Such pumps are commonly used in the sewage industry for pumping slurries.

Particularly with food doughs, and more particularly with candy dough, it is important to not bring air bubbles with the product into the pump. Such doughs do not flow well, if at all. For one, or both, of these reasons, or other reasons, progressing cavity pumps have not been employed for food doughs. That is, the inability of the dough to “flow” into the pump and/or the air induced or carried with the dough into the pump by force feeding have restricted the use of progressing cavity pumps in the food dough industry.

The present invention combines a roll feeder of known design with a progressing-cavity pump to provide a device which is suitable for food doughs and, particularly, candy dough. Use of a screw feeder intermediate the feeder and progressing cavity pump is desirable.

The roll feeder consists of two counter-rotating rollers with a gap between them and two scrapers that remove product from the rollers on the discharge side. The roll feeder forces dough into the progressing cavity pump inlet or into the screw that feeds the progressing cavity pumps, if used. In addition, the roll feeder removes air from the dough and is capable of mixing any minor liquid ingredients such as flavorings and/or colorings which may be dripped onto the rolls or the dough in the hopper, for example.

### BRIEF DESCRIPTION OF THE DRAWINGS

FIG. 1 is a schematic representation of a pump assembly in accordance with the present invention.

FIG. 2 is a schematic representation illustrating the operation of a roll feeder in accordance with the present invention.

FIG. 3 illustrates an alternative embodiment of a portion of the roll feeder illustrated in FIG. 2.

### DETAILED DESCRIPTION OF THE DRAWINGS

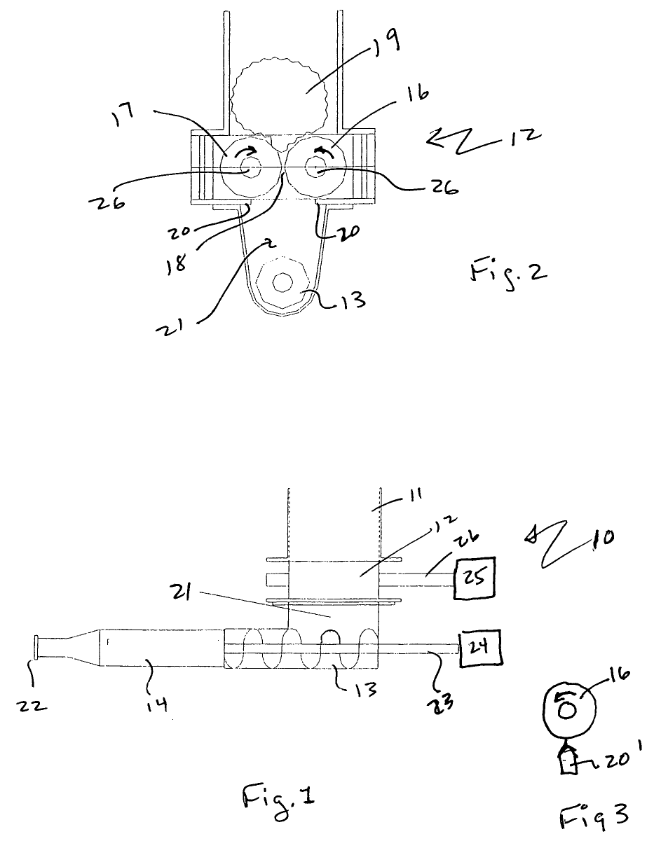

FIG. 1 illustrates a pump assembly in accordance with the present invention including a hopper 11, a roll feeder 12, a screw feeder 13 and progressing cavity pump 14. Progressing cavity pumps are known and are commercially available. In such pumps, a spiral, metal “rotor” rotates inside a tube which has a doubled-spiral stator cavity. A motor rotates the rotor which wobbles as it rotates in the stator, in known manner. For this application, the progressing cavity pump should have a solid metal rotor and stator. Otherwise, the pump may be as described in U.S. Pat. No. 1,892,217 which is hereby incorporated by reference.

The screw feeder 13 is also known in the art in combination with progressing cavity pumps. Indeed, they may be bought in combination as a single unit such as that sold by Moyno Industrial Products under Model No. 1FGJ3SJG and other manufacturers. While it has been found desirable for a screw feeder 13 to be employed at the inlet to the pump 14 to deliver dough to the pump 14, the screw feeder may not be required for all applications.

Dough to be pumped is delivered to the hopper 11 which serves to contain the dough and assists in maintaining it in position relative to the roll feeder 12. The cooperation of the hopper and roll feeder are illustrated in FIG. 2 wherein two (2) counter-rotating rollers 16 and 17 rotate in the direction of the arrows. The rollers 16 and 17 are located side by side having a gap or nip 18 of approximately ¼ inch between them. Rotation of the rollers forces the dough 19 through the nip 18 in a downward direction toward the screw 13. Scrapers 20 are provided to scrape most of the dough 19 from the rollers 16 and 17 leaving a layer of dough on the rolls approximately ⅛ inch thick. This dough coating on the rollers 16 and 17 facilitates the feeding of the roll feeder 12 while the scrapers 20 remove most of the dough. The action of the rollers 16 and 17 and scrappers 20 create a slightly pressurized area 21 at the inlet of the pump/screw assembly. In the event that excess dough (dough that is not removed by the pump assembly) is delivered to the chamber 21 by the roll feeder 12, it is forced backward through the nip 18 of the rolls 16 and 17 and into the ball of dough 19. The action of the rollers 16 and 17 at the nip 18 serves to de-air the dough as it passes through them rendering that dough particularly suitable for candy extrusion, for example.

As described, the present invention provides a pump assembly for dough-like material employing a progressing cavity pump assembly have an inlet and an outlet. A roll feeder is employed to deliver the dough-like material, under pressure, to the pump assembly. The pump assembly may include a screw feeder, as illustrated. In some instances the screw feeder may not be necessary. However, the pump assembly is considered desirable for most applications. In any case, the use of a progressing cavity pump allows the pumping of viscous dough-like material at high pressures suitable for extrusion. The outlet 22 of the pump 14 represents an extruder in this instance. For example, the outlet 22 may be shaped to form the dough into a deserved shape (i.e., a “die”). Other extruder configures may be used. Also, progressing cavity pumps are positive displacement pumps which allows a metering of the dough.

A shaft 23 drives both the screw 13 and pump 14, in known manner, the shaft 23 being powered by a motor 24. Similarly, a motor 25 drives shafts 26 of the rollers 16 and 17, the rollers 16 and 17 rotating with the shafts 26.

Obviously, many modifications and variations of the present invention are possible in light of the above teachings. For example, scrapers 20 illustrated in FIG. 2 are plate-like structures projecting into the area beneath the rollers 16. Alternatively, blade-like members 20′ (see FIG. 3) may be employed as scrapers for both rollers 16 and 17 (only rollers 16 being illustrated in FIG. 3). It is therefore to be understood that, within the scope of the appended claims, the invention may be practiced otherwise than as specifically described.

1. A pump assembly for dough-like material comprising:
a progressing cavity pump assembly having an inlet and an outlet;
roll feeder means having first and second side-by-side, counter-rotating rollers and a discharge, the roll feeder means discharge being adapted to deliver dough-like material, under pressure, to the pump assembly inlet.

2. The pump of claim 1 wherein the inlet of said pump assembly comprises screw feeder means.

3. The pump of claim 1 wherein the pump assembly comprises progressing cavity pump means and screw feeder means.

4. The pump of claim 1 wherein the pump assembly outlet comprises extruder means.

5. The pump of claim 1 wherein the first and second roll feeder means rollers are spaced from each other to define an input nip and further comprising hopper means adapted to contain dough-like material at the nip.

6. In a pump assembly for viscous food dough of the type having a roll feeder for delivering said dough, under pressure, to a pump, the improvement wherein the pump comprises a progressing cavity pump.

7. The pump assembly of claim 6 further comprising extruder means.

8. The pump assembly of claim 6 wherein the improvement further comprises screw feeder means interconnecting the roll feeder and progressing cavity pump.

9. A pump and extruder combination for dough-like material comprising:
a progressing cavity pump having an inlet and an outlet;
a screw feeder adapted to deliver dough-like material to the progressing cavity pump; and,
extruder means operatively connected to the outlet of the progressing cavity pump.
